(19) United States
(12) Patent Application Publication
(10) Pub. No.: US 2009/0005009 A1
(43) Pub. Date: Jan. 1, 2009

(54) Habit Braker On The Go Motivational Support System for Diet, Exercise and Quit Smoking

(76) Inventor: Yolanda Marsili, Menifee, CA (US)

Correspondence Address: Yolanda Marsili, 29790 Via Viento, Menifee, CA, 92584, US

(21) Appl. No.: 11/770,472

(22) Filed: Jun. 28, 2007

(51) Int. Cl. H04Q 7/22

(52) U.S. Cl. 455/412.1

(57) ABSTRACT

Placement of verbal motivational support messages in an audio format that allows end users to download one or several or all divisible tracts into a mobile phone, portable audio devices of any type or kind for the purpose of providing an instantly accessible and fully portable motivational support system to individuals to maintain their commitment to quit smoking, maintain a regular exercise program or to maintain a health diet program.

Motivational support system designed to be used by the end user through a personal mobile phone or any other portable audio device that accepts downloaded audio programs, and including CD players for the purpose of providing fully portable and therefore instant motivational support to assist the end user in resisting the urge to over eat or to maintain a regular exercise routine or to resist nicotine cravings to quit smoking in a way that is instantly accessible to the end user wherever they go.

### CROSS REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING

Not Applicable

### BACKGROUND OF THE INVENTION

Currently there is no system available for individuals to obtain instant motivational support to resist the urge to light up a cigarette when they are trying to quit smoking, to resist overeating, or to be motivated regularly to maintain a consistent exercise program through their mobile phone or portable audio device that they can access wherever they instantly and privately.

Smoking cessation methods continue to fail at an alarming rate and most smokers return to smoking within the first year at the rate of 95%. Furthermore, Americans continue to experience serious health problems related to unhealthy weight due to overeating and lack of a regular exercise routine. This system is designed to provide individuals with a lifetime of instant access to instant powerful motivational messages provided in numerous divisible audio tracts to maintain a health lifestyle and get healthy and fit. Most people cannot maintain smoking cessation efforts, diet plans, or exercise routines because they lose motivation and do not have access to continued easily accessible motivational support. This system solves the problem by placing that needed motivational support at their fingertips.

### BRIEF SUMMARY OF THE INVENTION

This on the go and fully portable motivational system was designed to help smokers to quit smoking by providing 24 hour instant, private and on the go personal coaching to resist the urges and cravings to light up again after they have quit smoking, to assist individuals to maintain motivation to maintain a regular exercise regiment or to resist cravings for overeating to assist in maintaining healthy weight. Currently there are no systems that provide motivational support in a way that end users can access wherever they go or wherever they are, privately and instantly to keep them on the right tract. This program provides a personal coach to keep people on the right and healthy tract in a way that they are most likely to use it and in a way that has never before been available.

### DETAILED DESCRIPTION OF THE INVENTION

Verbal motivational support messages provided in an audio recording that is configured as divisible tracts to allow the end user to download one or all of the motivational tracts into a portable device such as mobile phone, or other portable audio devices that can accept downloads allowing instant and easy access to a personal motivational coach to maintain a quit smoking plan and resist failure, to maintain a regular exercise program or to maintain a healthy diet plan.

1. Placement of verbal motivational support messages in an audio format that allows end users to download one or several or all divisible tracts into a mobile phone, portable audio devices of any type or kind for the purpose of providing an instantly accessible and fully portable motivational support system to individuals to maintain their commitment to quit smoking, maintain a regular exercise program or to maintain a health diet program.
